(19) United States
(12) Patent Application Publication
(10) Pub. No.: US 2010/0308495 A1
(43) Pub. Date: Dec. 9, 2010

(54) PROCESS FOR THE MANUFACTURE OF REACTIVE RUBBER PROCESS AIDS

(76) Inventors: Chandrasekaran R. PILLAI, Pepper Pike, OH (US); Hari CHANDRASEKARAN, Pepper Pike, OH (US); Krish C. CHANDRASEKARAN, Pepper Pike, OH (US)

Correspondence Address: PEARNE & GORDON LLP, 1801 EAST 9TH STREET, SUITE 1200, CLEVELAND, OH, 44114-3108, US

(21) Appl. No.: 12/618,917

(22) Filed: Nov. 16, 2009

Related U.S. Application Data
(60) Provisional application No. 61/217,824, filed on Jun. 5, 2009.

(51) Int. Cl. B29C 47/88; C08C 19/04

(52) U.S. Cl. 264/211.12; 525/332.7

(57) ABSTRACT

A process for the manufacture of rubber process aids from blends of vulcanized rubber powders, virgin polymers and thermoplastic resins. The process is carried out in a single stage using an extruder. The extruder is fed in three sections with feed hoppers. Vulcanized rubber powder of selected origin is fed into the hopper in the first section with part of the thermoplastic resin and oxidizing agents. The balance of the thermoplastic resin is fed in the second section. Virgin polymer is fed into the hopper in the third section. The temperature of the extruder is controlled and dwell time of the material passing through each of the extruder's sections is adjusted to ensure adequate mixing of all the polymers whereby a reactive rubber process aid in free flowing particulates is produced that acts as an excellent process aid in rubber processing.

### RELATED APPLICATION

This present invention claims the benefit of U.S. Provisional Patent Application 61/217,824 filed on Jun. 5, 2009.

### FIELD OF INVENTION

The present invention relates to novel rubber processing aids, specifically to solid, free flowing, particulate rubber process aids capable of improving rate of reduction of viscosity of rubber mix during compounding thereby reducing mix duration and energy consumption required to breakdown rubber, and imparting improved mold flow, dimensional stability of shaped uncured mix stocks and reducing die swell of mixes during the extrusion process and mold shrinkage to mold cured products.

### BACKGROUND OF THE INVENTION

A co-inventor of the present invention previously had developed a process for the manufacture of high grade devulcanized rubbers as disclosed in U.S. Pat. No. 5,731,358. This earlier process has been used to produce devulcanized rubbers on commercial scale for use in the manufacture of automotive molded parts. The resulting products using the devulcanized rubber (DVR) have improved physical characteristics over previous recycled rubber containing products. In addition, the manufacturing costs associated with producing the products with the DVR have been reduced significantly.

During the course of commercial scale production of the devulcanized rubber and designing specific formulations for use in tire fabrication, we found that a number processing problems had to be solved. Of main concerns were:
1) mixes with the devulcanized rubber had poor green strength which is the strength of unvulcanized rubber sheets, required for handling and shaping during fabrication of parts and before vulcanizing to set the rubber parts final shape;
2) these mixes exhibited poor building tack which is the ability of the sheets of mixed rubber to adhere when pressed together, essential for fabricating tire parts before they are assembled and vulcanized into finished tires in molds;
3) high viscosity of mixes that prevents ease of flow requiring higher energy or force in mixing and getting them shaped into desired shapes, especially intricately designed parts such as tire tread with ribbed patterns.

In order to overcome these problems, we decided to use the following additives to the rubber mixes containing devulcanized rubber:
1) ethylene vinyl acetate (EVA) to increase green strength;
2) various tackifying agent phenolic resins as a way of improving green strength and building tack;
3) process aids such as process oils and commercial grades of processing aids “Struktols,” zinc soaps of high molecular weight fatty acids, to reduce the viscosity.

In the case of EVA, while there was improvement in green strength of cold mix, warming up, as practiced in rubber tire building process, the green strength was once again poor. Tackifying agents, while improving somewhat the building tack, did not help the rubber sheets to bond together sufficiently well, especially in the absence of sufficient green strength resulting in breakage of sheets during fabrication. In viscosity reduction, both process oils-aromatic petroleum oil, naphthenic oil and paraffinic oil—while reducing the viscosity of mix, also substantially deteriorated green strength further. Similarly commercial process aid Struktols reduced viscosity but also further deteriorated green strength. In all of these cases, the additives-EVA, tackifying agents, process oils and process aids-had detrimental effects to varying degrees on the physical properties of cured rubber, especially the tensile properties.

In an effort to find a processing aid that would, when added, improve green strength, tack and reduce viscosity and at the same time not affect the physical properties, we chose liquid Natural Rubber supplied by Royal Elastomers under the label of DPNR which stands for Depolymerized Natural Rubber. DPNR comes in the form of viscous, dark, glue-like liquid in plastic bags and steel drums. The claim by Royal Elastomers states that the material is a “reactive process aid” that would vulcanize with the rubber matrix, hence would not deteriorate the physical properties of the vulcanized rubber. Both lab trials and factory scale mixes at 440 LB batches were made for the tests. The results were:
1) there was hardly any improvement in green strength compared to control mixes without any DPNR;
2) marginal improvement in tack, but less than in mixes with tackifying resins;
3) fair reduction in viscosity, higher than with oils and process aids.

However, there was no deterioration in the physical properties of the vulcanized rubber in which DPNR was present as a process aid additive. After many more trials with a combination of all of these additives, we found a way to improve the green strength and building tack in mixes with devulcanized rubber.

After numerous trials on coming up with a rubber based additive similar to DPNR, but with increased green strength and tack, we decided the solution had to be built into the Devulcanization process we used with U.S. Pat. No. 5,731,358. Thus, we conducted a series of experiments that led to discovery of the process of oxidizing a blend of vulcanized and virgin polymers/rubbers with chemical additives, mostly rubber peptizing agents, at elevated temperatures-higher than those in the previous U.S. Pat. No. 5,731,358—and addition of a thermoplastic resin at higher dosage as binder to have the finished product in free flowing pellets rather than in liquid for ease of handling and storage. We also discovered the use of maleic anhydride functionalized thermoplastic material from ExxonMobil sold under the brand name EXXCELOR® helped reduce porosity in the pellets and smoothen the surface finish. The equipment used in the process was a high Length/Diameter ratio extruder with features that allow addition of components at various sections or zones of the extruder barrel. We found that a range of products could be made using the products of this invention as additives, replacing previous devulcanized rubber made from using U.S. Pat. No. 5,731,358 depending on the composition of polymers, peptizing chemicals and binders.

The resulting rubber mixes had some unexpected properties. They are:
1) high green strength to mixes to which they are added—higher than any we have tested in our experiments;
2) higher tack to mixes-again higher than those we tested;
3) reduced viscosity of mixes more than mixes with traditional process oils and commercial process aids we tested.

In addition they also exhibit the following desirable characteristics:
1) the process aid of this invention vulcanizes with the rubber matrix in which it is present, similar to DPNR;
2) confer dimensional stability-reduced tendency to flow of mixes with low viscosity when shaped into forms in unvulcanized state before it goes to vulcanization process-reduced die swell and mold shrinkage that are characteristic of partially cross linked specialty rubbers; and reduced tendency to flow through fabrics in tire carcass where rubber and fabric are bonded together during vulcanization in the tire molding.

In addition, we also found that the process aid confers the ability to hold substantially higher levels of mineral fillers such as clay without affecting in any way the processability, than mixes with any of the process oils and commercial process aids that we had tested. This aspect in particular will greatly help in reducing product cost where typical material costs are about 65 to 75 percent of the total cost of rubber products. The cost reduction using the product of this invention is in the order of 20 to 30%.

We have examined many other patents that seem to fall in similar category. They are:
1) U.S. Pat. No. 5,622,998 issued to Tanaka, et al.
It describes a production process of depolymerized natural rubber. That patent differs from our invention in that the process describes a method producing a liquid product through subjecting natural rubber dissolved in an organic solvent, to oxidation by bubbling air through in the presence of radical forming agents in the solution. It is totally different from the present invention in that the product from Tanaka's invention is liquid, as opposed to the present invention's product, which is solid. The process of the present invention does not comprise use of solvents and seems to be for different applications than Tanaka's.
2) U.S. Pat. No. 5,856,600 issued to Tanaka, et al.
Like Tanaka's earlier patent in (a) above, it also describes a production process for depolymerized natural rubber. A difference between Mr. Tanaka's earlier U.S. Pat. No. 5,852,600 and this one is that in this patent the process uses diluted deprotenized natural rubber latex in place of natural rubber dissolved in solvent. Again this patent differs from our invention in that the process describes a method for producing a liquid product through subjecting deprotenized natural rubber liquid latex to oxidation by bubbling air through with addition of radical forming agents in the latex. It is totally different from the present invention in that the product from Tanaka's invention is liquid, using deprotenized latex—which costs substantially more than our polymer additives—with air to oxidize. The process of the present invention does not comprise use of deprotenized latex and seems to be for different applications than Tanaka's.
3) U.S. Pat. No. 7,491,757 issued to Qiao, et al.
It describes a process for manufacture of fully vulcanized powdery rubber blended with plastic by conventional method for blending rubbers. It is different from our invention primarily because the product and its intended use are different. In our invention it is a process aid versus Qioa's thermoplastic rubber. In addition the materials used are different: in ours they are blends of vulcanized rubber, virgin polymer and thermoplastic resins, while Qiao's are a fully vulcanized powdery rubber and plastic.
4) U.S. Pat. No. 6,313,183 issued Pillai, et al.
The inventors are part of the team that invented the present process for this application. The process in the U.S. Pat. No. 6,313,183 relates to a different product that is thermoplastic rubber from vulcanized scrap rubbers and resinic plastics. The product is thermoplastic rubber as opposed to the present invention which forms a process aid intended for different applications and uses.
5) Article published in Polymer Engineering and Science in 2004 by authors Amiya R. Tripathy, Drew E. Williams and Richard J. Farris (Dean of the Faculty of Polymer Science and Engineering, University of Massachusetts).
The article describes a process of disposing scrap tires by degrading rubber from these scrap tires-both natural rubber and styrene butadiene rubber compositions with carbon black, oil and other components-at 310° C. for 1 hour under Nitrogen atmosphere and 4 MPa pressure produced in their laboratories and tested for use as rubber plasticizer replacing oils in rubber compounding. Thus, their process differs in conditions of temperature, atmosphere and pressure from the present invention. Their product is a viscous liquid, different from our free flowing pellets and limited to use for reducing viscosity.

None of the prior processes and compositions discussed above teach a process for preparing a rubber process aid material comprising of polymer blends oxidized with rubber peptizers and thermoplastic resins in a one stage continuous process at elevated temperatures. The product, thus produced, has been found through laboratory and commercial scale productions to be excellent reactive process aid in rubber processing. The product of the present invention when added to rubber mixes provides the following benefits:
Reduce mix viscosity for ease of processing without the risk of process aids such as oils from migrating from the cured products, as the product of this invention vulcanizes with the rest of the rubber matrix;
Reduces energy used in mixing due to softer material and reduces the mixing time to achieve a given viscosity;
Ease of handling as they come in the form of pellets as opposed most process aids that are liquid;
Confers dimensional stability-resists cold flow-preventing shaped uncured stocks from going out of shape before curing;
Reduces shrinkage in calendared sheets;
Reduces die swell in the extrusion process.

### SUMMARY OF INVENTION

In general, the invention features a process for the manufacture of a rubber process aid. The following mixture is adding into an extruder: vulcanized rubber powder, thermoplastic resin, an oxidizing peptizing agent and rubber activators. The vulcanized rubber powder can be present in an amount from 40 to 80% based on a total weight of the mixture, in particular, in an amount from 50 to 75% by weight. The thermoplastic resin is present in an amount of from about 0.5 to about 50.0% by weight based on a total weight of the mixture. The thermoplastic resin is selected from the group consisting of low density polyethylene, polypropylene, ethylene vinyl acetate, high density polyethylene and mixtures thereof. The oxidizing peptizing agent is present in an amount from 0.01 to 6.0% by weight based on the weight of the vulcanized rubber powder. The oxidizing peptizing agent is selected from the group consisting of Diphenyl Guanadine, 2-Mercapto Benzothiazole, Dibenzothiazole disulphide and mixtures thereof. The rubber activators are present in an amount from about 0 to 10.0% by weight (e.g., more specifically from 0.1 to 3% by weight in all embodiments herein) based on the weight of the vulcanized rubber powder. The rubber activators are Stearic Acid and Zinc Oxide. The mixture is subjected to a temperature in the range of about 80° C. to about 220° C. in the extruder.

One embodiment of the invention features a process for the manufacture of a rubber process aid comprising extruding in an extruder three compositions in three axially spaced sections (i.e., sequentially, a first section followed by a second section followed by a third section). Added to a first section is a first composition including vulcanized rubber powder (e.g, used in an amount as described above) and thermoplastic resin. The thermoplastic resin is present in an amount from about 0.5 to about 6.0% by weight based on a total weight of the compositions. The thermoplastic resin is selected from the group consisting of low density polyethylene, polypropylene, ethylene vinyl acetate, high density polyethylene and mixtures thereof. The mixture is subjected to a temperature in the range of about 80° C. to about 220° C. in the extruder.

A second section addition and treatment comprises adding to a second section of the extruder second thermoplastic resin in an amount of 0.5% to 50% by weight based on the total compositions. The second thermoplastic resin is selected from the group consisting of low density polyethylene, polypropylene, ethylene vinyl acetate, high styrene styrene butadiene rubber, high density polyethylene. The second section, with the second thermoplastic resin in combination with the mixture flowing from the first section, is subjected to a temperature of 120° C. to about 220° C. in the extruder.

A third section addition and treatment comprises adding to a third section of the extruder a virgin polymer present in an amount of 2.0% to 50% by weight of the total weight of the compositions. The third section, with virgin polymer composition in combination with the mixture and second thermoplastic resin flowing from the second section, is subjected to a temperature of 80° C. to about 220° C. in the extruder.

Referring to a more specific embodiment of the invention, it is an object to provide compositions and processing techniques for the manufacture of reactive rubber process aids from a blend of polymers in an extruder adding them in three axially spaced zones through feed hoppers at controlled temperature and passage of material through each section adjusted to ensure a homogenous mix. A process for the manufacture of a rubber process aid includes feeding a mixture of a first composition comprising vulcanized rubber powder (e.g., used in an amount described above), thermoplastic resin, oxidizing peptizing agent and rubber activators into a first section of the extruder. The thermoplastic resin is present in an amount from about 0.5 to about 6.0% by weight based on a total weight of the compositions. The thermoplastic resin is selected from the group consisting of low density polyethylene, polypropylene, ethylene vinyl acetate, high density polyethylene and mixtures thereof. The oxidizing peptizing agent is present in an amount from about 0.01 to 6.0% by weight based on the weight of the vulcanized rubber powder. The oxidizing peptizing agent is selected from the group consisting of Diphenyl Guanadine, 2-Mercapto Benzothiazole, Dibenzothiazole disulphide and mixtures thereof. The rubber activators are present in an amount from about 0 to 10.0% by weight based on the weight of the vulcanized rubber powder. The rubber activators are Stearic Acid and Zinc Oxide (e.g., blended in a ratio of 1:2). The mixture is subjected to a temperature in the range of about 80° C. to about 220° C. in the extruder.

A second section addition and treatment includes adding to a second section of the extruder second thermoplastic resin in an amount of 0.5% to 50% by weight based on the weight of the total compositions. The second thermoplastic resin is selected from the group consisting of low density polyethylene, polypropylene, ethylene vinyl acetate, high styrene styrene butadiene rubber, high density polyethylene. The second section, with the second thermoplastic resin in combination with the mixture flowing from the first section, is subjected to a temperature of 120° C. to about 220° C. in the extruder.

A third section addition and treatment includes adding to a third section of the extruder virgin polymer in an amount of 2.0% to 50% by weight of the total weight of the compositions. The virgin polymer is selected from the group consisting of Ethylene Propylene Diene Monomer (EPDM) rubber, Ethylene Propylene Rubber, Styrene Butadiene Rubber, Polybutadiene Rubber, Polyisoprene Rubber, Natural Rubber and mixtures thereof. The third section, with the virgin polymer in combination with the mixture and second thermoplastic resin flowing from the second section, is subjected to a temperature of 80° C. to about 220° C. in the extruder. The extrusion is cooled (e.g., by passing through a water bath) at temperatures between 10° C. and 30° C. cut into an extruded product (e.g., by palletizing with a rotary cutter) to produce a free flowing, solid reactive rubber process aid for use in rubber compounding and processing.

Referring now to specific features of the invention that are applicable to any of the embodiments discussed above, the vulcanized rubber powder can be derived from grinding used truck tires, passenger tires and agricultural tires, and separating the rubber composition from fiber and metal. The vulcanized rubber powder can be derived from grinding used butyl rubber tire curing bladders and used butyl rubber tire inner tubes. The vulcanized rubber powder can be derived from grinding scrap EPDM rubber Roofing Membranes, extrusion profiles, tubes, hoses and molded parts. Thermoplastic resin in the first section is low density polyethylene and the first section temperature is in the range of about 80° C. to about 170° C. The second thermoplastic resin is polypropylene and the second section temperature is in the range of about 185° C. to about 220° C. The thermoplastic resin in the first section is Ethylene Vinyl Acetate. The thermoplastic resin in the first section and the second thermoplastic resin are high density polyethylene and the temperature in the first and second sections is in the range of about 130° C. to about 170° C. The virgin polymer is EPDM Rubber and the third section temperature is in the range of about 120° C. to about 170° C. The virgin polymer is Styrene Butadiene Rubber and the third section temperature is in the range of about 120° to about 170° C. The virgin polymer is polyisoprene rubber and the third section temperature is in the range of about 80° C. to about 150° C. The virgin polymer is Natural Rubber and the third section temperature is in the range of about 80° C. to about 150° C. The virgin polymer is polybutadiene rubber and the third section temperature is in the range of about 80° C. to about 170° C. The oxidizing peptizing agent is Diphenyl Guanadine. The oxidizing peptizing agent is 2-Mercapto Benzothiazole. The oxidizing peptizing agent is Dibenzothiazole disulphide.

A preliminary stage addition includes adding to the mixture of the first section a preliminary additive which is a compatibilizer in an amount of from about 0.5 to about 5.0% by weight based on the total weight of the compositions. The compatibilizer is selected from the group of polymers consisting of Epoxidized Natural Rubber, maleic anhydride functionalized elastomeric ethylene copolymers and mixtures thereof. This preliminary stage is optional, used for shiny surface appearance and for the materials intended for use in impact modification of plastics and preparation of thermoplastic rubber compositions.

Further objects and advantages of our invention will become apparent from a consideration of the process descriptions.

The following examples are provided merely to illustrate the present invention, and it is to be understood the invention is not limited thereto. All amounts of the various ingredients in the examples and elsewhere in the specification are by weight unless otherwise specified.

### EXAMPLE 1

A Reactive Rubber Process Aid was produced from a composite of powdered vulcanized tire rubber, ethylene vinyl acetate and ethylene propylene diene monomer (EPDM) rubber using the process of the present invention, adding the components at first, second and third hopper of the twin screw extruder as described below:

Section one hopper of the extruder: feed rate 70% powdered tire rubber with 6% of ethylene vinyl acetate and a mixture of 0.04% Diphenyl Guanadine, 0.06% of Mercaptobenzothiazole, 0.10% of Dibenzothiazole Disulphide, 0.2% of Stearic Acid and 0.4% Zinc Oxide with temperature set at 198° C.

Second section hopper of the same extruder: addition at feed rate 10% of low density polyethylene with temperature set at 180° C.

Third section hopper of the same extruder: additions at feed rate of 5.9% ethylene propylene diene monomer (EPDM) rubber and at feed rate of 13% styrene butadiene rubber with temperature set at 160° C.

All % weights shown are based on the total weight of the finished mix.

This example produced a process aid that was used in rubber compounding to reduce mixing time and viscosity of the mix besides conferring to the compound good dimensional stability, lower shrinkage of sheeted rubber.

Test Mix Formulation and Properties:

Test mix used for evaluating the process aid from example 1 was from commercial production of leading agricultural tire manufacturing company's regular tire tread material with composition as shown in Table I. And, Table II shows Formulations with varying levels of the process aid from this Example 1 with test data.

TABLE I
Tire Tread Mix Formulation
Base Mix Ref: QT-541
Mix Ref:

| Material | Parts | % Parts |
|---|---|---|
| Natural Rubber | 50.0 | 20% |
| Styrene Butadiene Rubber Grade 1502 | 14.0 | 6% |
| Oil Extended Styrene Butadiene Rubber Grade 1712 | 49.5 | 20% |
| Carbon Black Grade N 330 | 85.0 | 34% |
| Ground Tire Rubber - size 40 mesh | 8.0 | 3% |
| Stearic Acid | 1.5 | 1% |
| Paraffin Wax | 3.5 | 1% |
| Rubber Antioxidant (TQ) | 1.0 | 0% |
| Rubber Antiozonant (6PPD) | 2.5 | 1% |
| Aromatic Oil | 28.0 | 11% |
| Zinc Oxide | 5.0 | 2% |
| EcoreenT** | 0.0 | 0% |
| Total | 248.0 | 100% |

TABLE II
Test Mixes with varying levels of Process Aid from Example 1.

| Ref: | 9089 | 9090 | 9091 | 9092 | 9093 |
|---|---|---|---|---|---|
| Base Mix from Table I | 100 | 95 | 92.5 | 90 | 85 |
| Ecoreen T ** | 0 | 5 | 7.5 | 10 | 15 |
| Rubber Accelerator TBBS | 0.4 | 0.4 | 0.4 | 0.4 | 0.4 |
| Sulfur | 0.8 | 0.8 | 0.8 | 0.8 | 0.8 |
| Mooney Viscosity Index ML | | | | | |
| (1 + 4) minutes at 100° C. | | | | | |
| Initial Viscosity | 81.5 | 71 | 68.4 | 66.9 | 62.3 |
| Final Viscosity | 62.5 | 57.1 | 53.8 | 52.4 | 49.9 |
| Rheometer test at 390° F. (198.9° C.) | | | | | |
| ML or Minimum Torque | 2.3 | 2.22 | 2.12 | 2 | 1.95 |
| MH or Maximum Torque | 11.34 | 10.29 | 9.63 | 9.27 | 8.66 |
| Torque at 90% Cure or TC90 | 0.99 | 0.99 | 1.03 | 0.92 | 0.95 |
| Torque at 1% cure or TS1 | 0.35 | 0.38 | 0.4 | 0.37 | 0.4 |
| Tensile Strength pounds | 3300 | 3250 | 3200 | 3260 | 3240 |
| per square inch (psi) | | | | | |
| Stress at 100% psi | 311 | 325 | 325 | 325 | 335 |
| Stress at 300% psi | 1500 | 1480 | 1440 | 1435 | 1460 |
| Elongation at Break % | 570 | 500 | 510 | 500 | 500 |
| Hardness, Shore A | 68 | 66 | 67 | 67 | 68 |

All mixes processed well, and were softer and smoother than control mix without Ecoreen T ** Agricultural Tire produced from Mix 9091 had good surface finish and reflected the good representation of mold patterns. Uncured stocks showed better dimensional stability and resistance to cold flow resistance.
** Reactive Rubber Process Aid from Example 1 is referred here as “ECOREEN T”

### EXAMPLE 2

A Reactive Rubber Process Aid was produced from a composite of powdered used tire curing butyl rubber bladders, ethylene vinyl acetate and ethylene propylene diene monomer (EPDM) rubber using the process of the present invention, adding the components at first, second and third hopper of the twin screw extruder as described below:

Section one hopper of the extruder: feed rate 65% powdered butyl bladder rubber with 6% of ethylene vinyl acetate and 0.1% of Dibenzothiazole disulphide and 2.1% of 1:2 ratio mixture of stearic acid zinc oxide with temperature set at 200° C.

Second section hopper of the same extruder: addition at feed rate 15% of ethylene vinyl acetate with temperature set at 200° C.

Third section hopper of the same extruder: additions at feed rate of 4.8% ethylene propylene diene monomer (EPDM) rubber with temperature set at 200° C.

All % weights shown are based on the total weight of the finished mix.

This example produced a process aid that was used in tire inner liner rubber compounding to reduce mixing time and viscosity of the mix besides conferring to the compound good dimensional stability, lower shrinkage of sheeted rubber.

Test mix used for evaluating the process aid from the example 2 was referred to as QF-171. Test mix recipe is shown in Table III below.

TABLE III
Formulation of Base Mix used in Tire Inner Liner
Butyl Tire Inner Liner Mix

| Mix Ref: QF 171 | Parts | Percent |
|---|---|---|
| Brominated Butyl Rubber | 70 | 31% |
| Natural Rubber | 30 | 13% |
| GPF Carbon Black N 660 | 60 | 26% |
| Clay | 40 | 18% |
| Stearic Acid | 1 | 0% |
| Naphthenic Oil | 15 | 7% |
| Piccopale 100 - Process aid Resin | 5 | 2% |
| Zinc Oxide | 5 | 2% |
| Sulfur | 0.5 | 0% |
| Rubber Accelerator - MBTS | 1 | 0% |
| Total | 227.5 | 100% |

TABLE IV
Test Mixes with varying levels of Process
Aid from Example 2 in Mix QF-171

| Ref: QF 171 | 9097 | 9098 | 9099 |
|---|---|---|---|
| Mix from Table III | 100 | 95 | 90 |
| Ecoreen B *** | 0 | 5 | 10 |
| Sulfur | 0 | 0 | 0.02 |
| Mooney Viscosity - | 64.7 | 63.5 | 30.3 |
| ML (1 + 4)′ at 100° C. | | | |
| Rheometer test at | | | |
| 390° F. (198.9° C.) | | | |
| ML or Minimum Torque | 1.59 | 1.43 | 1.32 |
| MH or Maximum Torque | 8.25 | 7.06 | 6.65 |
| Torque at 90% Cure or TC90 | 1.2 | 1.3 | 1.25 |
| Torque at 1% cure or TS1 | 0.45 | 0.51 | 0.50 |
| Tensile strength psi | 1855 | 1740 | 1655 |
| Stress at 100% psi | 260 | 250 | 255 |
| Elongation at Break % | 955 | 840 | 830 |
| Hardness, Shore A | 56 | 57 | 59 |

*** Ecoreen B refers to Reactive Rubber Process Aid from Example 2.

ML means Mooney Viscosity Index to measure viscosity of rubbers. MH means maximum torque and ML means minimum torque during tests to determine viscosity changes during vulcanization of the compounded rubber as in the examples. ML 1+4 means the measurement parameters used in testing the Mooney Viscosity Index: M is Mooney meter, L for Large rotor used in the test, 1 means 1 minute pre heat and 4 means 4 minutes of test time at a given temperature, in this case at 100° C. It is written as ML(1+4) at 100° C.

Viscosity referred to as ML 1+4′ (stands for measurement in Mooney Viscometer at 100° C. with 1 minute warm up and 4 minutes of testing).

There was clear drop in viscosity of mixes with the process aid from example 2 compared to control mix 9097 without the process aid.

### EXAMPLE 3

A Reactive Rubber Process Aid was produced from a composite of powdered scrap EPDM roofing membrane, ethylene vinyl acetate and ethylene propylene diene monomer (EPDM) rubber using the process of the present invention, adding the components at first, second and third hopper of the twin screw extruder as described below:

Section one hopper of the extruder: feed rate 77% powdered vulcanized EPDM roofing membrane rubber with 6% of ethylene vinyl acetate and 0.3% of 1:2 ratio mixture of Diphenyl Guanadine and Dibenzothiazole disulphide and 2.1% of 1:2 ratio mixture of stearic acid zinc oxide with temperature set at 200° C.

Second section hopper of the same extruder: addition at feed rate 15% of ethylene vinyl acetate with temperature set at 200° C.

Third section hopper of the same extruder: additions at feed rate of 5.2% virgin ethylene propylene diene monomer (EPDM) rubber with temperature set at 180° C.

All % weights shown are based on the total weight of the finished mix.

This example produced a process aid that was used in floor mat rubber compounding to reduce mixing time, viscosity of the mix and increase filler loading in addition to conferring to the compound good dimensional stability, lower shrinkage of sheeted rubber.

Lab tests confirmed similar findings on process aid from the example 3 to those in examples 1 and 2.

While particular embodiments of the invention have been described, it would be understood, of course, that the invention is not limited thereto, and that many obvious modifications and variations can be made, and that such modifications and variations are intended to fall within the scope of the appended claims.

What is claimed is:

1. A process for the manufacture of a rubber process aid comprising:
forming a mixture by adding in an extruder vulcanized rubber powder, thermoplastic resin, an oxidizing peptizing agent and rubber activators, wherein said thermoplastic resin is present in an amount of from about 0.5 to about 50.0% by weight based on a total weight of the mixture, said thermoplastic resin being selected from the group consisting of low density polyethylene, polypropylene, ethylene vinyl acetate, high density polyethylene and mixtures thereof, said oxidizing peptizing agent is present in an amount from 0.01 to 6.0% by weight based on the weight of said vulcanized rubber powder, said oxidizing peptizing agent being selected from the group consisting of Diphenyl Guanadine, 2-Mercapto Benzothiazole, Dibenzothiazole disulphide and mixtures thereof; and
subjecting said mixture to a temperature in the range of about 80° C. to about 220° C. in the extruder.

2. A process for the manufacture of a rubber process aid comprising: extruding in an extruder three compositions in three axially spaced sections;
1) a first section addition and treatment comprising adding to a first section of the extruder a mixture of a first composition comprising vulcanized rubber powder and thermoplastic resin in a first section of the extruder, said thermoplastic resin being present in an amount from about 0.5 to about 6.0% by weight based on a total weight of the compositions, said thermoplastic resin being selected from the group consisting of low density polyethylene, polypropylene, ethylene vinyl acetate, high density polyethylene and mixtures thereof, and
subjecting said mixture to a temperature in the range of about 80° C. to about 220° C. in the extruder; and
2) a second section addition and treatment comprising:
a) adding to a second section of the extruder a second thermoplastic resin present in an amount of 0.5% to 50% by weight based on the total weight of the compositions, said second thermoplastic resin being selected from the group consisting of low density polyethylene, polypropylene, ethylene vinyl acetate, high styrene styrene butadiene rubber, high density polyethylene, and
(b) subjecting the second section with said second thermoplastic resin in combination with the mixture flowing from the first section to a temperature of 120° C. to about 220° C. in the extruder, and
3) a third section addition and treatment comprising:
(a) adding to a third section of the extruder a virgin polymer in an amount of 2.0% to 50% by weight of the total weight of the compositions; and
(b) subjecting the third section with said virgin polymer in combination with the mixture and said second thermoplastic resin flowing from the second section to a temperature of 80° C. to about 220° C. in the extruder.

3. A process for the manufacture of a rubber process aid comprising:
extruding in an extruder three compositions in three axially spaced sections;
a first section addition and treatment comprising
adding to a first section of the extruder a mixture of a first composition comprising vulcanized rubber powder, thermoplastic resin, oxidizing peptizing agent and rubber activators in a first section of said extruder:
wherein said thermoplastic resin is present in an amount from about 0.5 to about 6.0% by weight based on a total weight of the compositions, said thermoplastic resin being selected from the group consisting of low density polyethylene, polypropylene, ethylene vinyl acetate, high density polyethylene and mixtures thereof; said oxidizing peptizing agent is present in an amount from about 0.01 to 6.0% by weight based on the weight of the vulcanized rubber powder, said oxidizing peptizing agent being selected from the group consisting of Diphenyl Guanadine, 2-Mercapto Benzothiazole, Dibenzothiazole disulphide and mixtures thereof and said rubber activators are present in an amount from about 0 to 10.0% by weight based on the weight of said vulcanized rubber powder, said rubber activators being Stearic Acid and Zinc Oxide; and
subjecting said mixture to a temperature in the range of about 80° C. to about 220° C. in the extruder; and
a second section addition and treatment comprising:
a) adding to a second section of the extruder a second thermoplastic resin present in an amount of 0.5% to 50% by weight based on the weight of the total compositions, said second thermoplastic resin being selected from the group consisting of low density polyethylene, polypropylene, ethylene vinyl acetate, high styrene styrene butadiene rubber, high density polyethylene; and
(b) subjecting the second section with said second thermoplastic resin in combination with the mixture flowing from the first section to a temperature of 120° C. to about 220° C. in the extruder; and
a third section addition and treatment comprising:
(a) adding to a third section of the extruder a virgin polymer present in an amount of 2.0% to 50% by weight of the total weight of the compositions, said virgin polymer being selected from the group consisting of Ethylene Propylene Diene Monomer (EPDM) rubber, Ethylene Propylene Rubber, Styrene Butadiene Rubber, Polybutadiene Rubber, Polyisoprene Rubber, Natural Rubber and mixtures thereof;
(b) subjecting the third section with said virgin polymer in combination with the mixture and said second thermoplastic material flowing from the second section to a temperature of 80° C. to about 220° C. in the extruder;
(c) cooling the extrusion; and
(d) cutting a resulting extruded product to produce a free flowing, solid reactive rubber process aid for use in rubber compounding and processing.

4. The process in accordance with claim 3, wherein said vulcanized rubber powder is derived from grinding used truck tires, passenger tires and agricultural tires, and separating the rubber composition from fiber and metal.

5. The process in accordance with claim 3, wherein said vulcanized rubber powder is derived from grinding used butyl rubber tire curing bladders and used butyl rubber tire inner tubes.

6. The process in accordance with claim 3, wherein said vulcanized rubber powder is derived from grinding scrap EPDM rubber Roofing Membranes, extrusion profiles, tubes, hoses and molded parts.

7. The process in accordance with claim 3, wherein said thermoplastic resin in said first section is low density polyethylene and said first section temperature is in the range of about 80° C. to about 170° C.

8. The process in accordance with claim 3, wherein said second thermoplastic resin is polypropylene and said second section temperature is in the range of about 185° C. to about 220° C.

9. The process in accordance with claim 3, wherein said thermoplastic resin in said first section is Ethylene Vinyl Acetate.

10. The process in accordance with claim 3, wherein said thermoplastic resin in said first section and said second thermoplastic resin are high density polyethylene and said temperature in said first and second sections is in the range of about 130° C. to about 170° C.

11. The process in accordance with claim 3, wherein said virgin polymer is said EPDM Rubber and said third section temperature is in the range of about 120° C. to about 170° C.

12. The process in accordance with claim 3, wherein said virgin polymer is said Styrene Butadiene Rubber and said third section temperature is in the range of about 120° to about 170° C.

13. The process in accordance with claim 3, wherein said virgin polymer is said polyisoprene rubber and said third section temperature is in the range of about 80° C. to about 150° C.

14. The process in accordance with claim 3, wherein said virgin polymer is said Natural Rubber and said third section temperature is in the range of about 80° C. to about 150° C.

15. The process in accordance with claim 3, wherein said virgin polymer is said polybutadiene rubber and said third section temperature is in the range of about 80° C. to about 170° C.

16. The process in accordance with claim 3, wherein said oxidizing peptizing agent is said Diphenyl Guanadine.

17. The process in accordance with claim 3, wherein said oxidizing peptizing agent is said 2-Mercapto Benzothiazole.

18. The process in accordance with claim 3, wherein said oxidizing peptizing agent is said Dibenzothiazole disulphide.

19. The process in accordance with claim 3 further comprising a preliminary stage addition at said first section of:
(a) adding to said mixture a preliminary additive which is a compatibilizer in an amount of from about 0.5 to about 5.0% by weight based on the total weight of the compositions, said compatibilizer being selected from the group of polymers consisting of Epoxidized Natural Rubber, maleic anhydride functionalized elastomeric ethylene copolymers and mixtures thereof.
